(19) United States
(12) Patent Application Publication
(10) Pub. No.: US 2025/0061635 A1
(43) Pub. Date: Feb. 20, 2025

(54) DIGITAL ACCESSIBILITY IN THE METAVERSE

(71) Applicant: Wells Fargo Bank, N.A., San Francisco, CA (US)

(72) Inventor: Aparna M. Dave, Houston, TX (US)

(21) Appl. No.: 18/055,644

(22) Filed: Nov. 15, 2022

(51) Int. Cl. G06T 13/40; G06F 3/01; G09B 21/00

(52) U.S. Cl. CPC G06T 13/40; G06F 3/011; G09B 21/00

(57) ABSTRACT

A computer system for metaverse digital accessibility can include one or more processors and non-transitory computer-readable storage media encoding instructions which, when executed by the one or more processors, causes the computer system to create an accessibility characteristics engine programmed to receive one or more accessibility characteristics associated with a user, an environment engine programmed to generate an environment for an avatar associated with the user based on the received one or more accessibility characteristic, and an accessibility support engine programmed to provide an accessibility aide to the avatar associated with the user.

### BACKGROUND

The metaverse can be envisioned as an immersive world that is typically facilitated through the use of virtual and augmented reality devices. The metaverse can include a virtual representation of most, if not all, aspects of the physical world in which we live. This metaverse can be accessible to anyone with an Internet connection. Internet access thus democratizes metaverse accessibility in a way that would be difficult in the real world.

### SUMMARY

Examples provided herein are directed to providing digital accessibility in the metaverse.

According to one aspect, a computer system for metaverse digital accessibility includes one or more processors and non-transitory computer-readable storage media encoding instructions which, when executed by the one or more processors, causes the computer system to create an accessibility characteristics engine programmed to receive one or more accessibility characteristics associated with a user, an environment engine programmed to generate an environment for an avatar associated with the user based on the received one or more accessibility characteristic, and an accessibility support engine programmed to provide an accessibility aide to the avatar associated with the user.

In another aspect, the one or more accessibility characteristics comprise at least one of a vision impairment, a hearing impairment, a mobility impairment, a language barrier, a susceptibility to strokes, a susceptibility to seizures, a susceptibility to migraines, and a speech impairment. In another aspect, the accessibility aide is one or more of an accessibility tool and a service avatar. In a further aspect, the service avatar provides one or more of navigation, interpretation, and emotional support. In a still further aspect, the service avatar is an artificial intelligence.

In another aspect, the environment includes one or more features, the one or more features including lighting with reduced brightness, reduction or elimination of flashing lights, a guiderail, auditory directions, haptic directions, tactile directs, a user's perception of spare around them, a user's perception of height, and subtitles. In a further aspect, the computer system further includes a database, the database including one or more feature-characteristic pairs, wherein the each of the one or more feature-characteristic pairs comprise an accessibility characteristic and one or more associated feature.

In another aspect, the computer system further includes a toolkit engine programmed to generate a toolkit of one or more features and one or more aides and wherein the toolkit is provided to a service provider such that the one or more features and the one or more aides are configured to be implemented in an event space by the service provider. In a further aspect, the one or more features and one or more aides in the toolkit are determined according to a guestlist associated with the event space by the service provider. In another further aspect, the one or more features and one or more aides in the toolkit are determined according to a first set of accessibility characteristics associated with one or more users present in the event space. In still another further aspect, the one or more features and one or more aides in the toolkit are updated according to a second set of accessibility characteristics associated with one or more users entering the event space. In a still further aspect, the one or more features and one or more aides in the toolkit are updated according to a second set of accessibility characteristics associated with one or more users exiting the event space.

According to another aspect, a method of providing digital accessibility to a user in a metaverse setting includes receiving one or more accessibility characteristics associated with the user and generating a featured environment to the metaverse for an avatar of the user to interact in, the featured environment including one or more features, each feature of the one or features associated with at least one of the one or more accessibility characteristics.

In another aspect, the method further includes evaluating a level of accessibility experienced by the user. In a further aspect, the method further includes determining that the level of accessibility experienced by the user is below a predetermined threshold and in response to determining that the level of accessibility experienced by the user is below a predetermined threshold, regenerating the featured environment to include an additional feature.

In another aspect, the method further includes generating a service avatar to provide real-time accessibility support to the avatar of the user.

In another aspect, determining one or more accessibility characteristics associated with the user includes receiving a user profile and retrieving the one or more accessibility characteristics form the user profile.

In another aspect, the method further includes authenticating the user, wherein a method of authentication is selected according the one or more accessibility characteristics. In a further aspect, the method of authentication is selected from keyboard password authentication, dictation password authentication, and biometric authentication. In another aspect, determining one or more accessibility characteristics associated with the user includes determining one or more accessibility devices are associated with the user and determining one or more accessibility characteristics associated with the one or more accessibility devices.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system for providing digital accessibility in a metaverse.

FIG. 2 shows example logical components of a server of the system of FIG. 1.

FIG. 3 shows an example workflow executed by the server device of FIG. 2.

FIG. 4 shows example physical components of the server device of FIG. 2.

### DETAILED DESCRIPTION

This disclosure relates to providing digital accessibility, including tools and environments to be deployed by a financial institution to facilitate broad-based access to banking products and services in the metaverse. There is significant opportunity in the metaverse to engage and interact and improve financial success for people with disabilities and other accessibility barriers in ways that the physical world may not support or enable.

An example embodiment includes the design and deployment of spaces or environments in the metaverse specifically for those with disabilities or other barriers to accessibility, such as a featured environment where features of the featured environment reduce accessibility barriers typically experienced by a disabled user via the user's avatar. Different spaces or environments may be designed or featured based on the type and degree of disability.

For example, users susceptible to experiencing stroke, seizure, migraine, etc. when exposed to excessive bright or flashing light have the user's avatar populated into a featured environment of the metaverse with features including lights with reduced or adjustable brightness, and lights which are either on or off and do not flash. In another example, a user with vision impairment will have the user's avatar populated into a featured environment of the metaverse with a service avatar to provide guidance through the metaverse space or environment.

Embodiments can incorporate authentication features and integrate a user's accessibility characteristics with the user's accessibility profile. Once a person is authenticated by a space within the metaverse, any corresponding disabilities and other accessibility considerations may be immediately identified from a corresponding profile, and the user's avatar may be transported to an area or environment in which the experience supports the user's unique needs. In embodiments, the implementation tailors the delivery of products, communications, and disclosures via corresponding modes of communication (e.g., voice, haptics, audio, visual, mobility, etc.) based on the user's particular needs.

Third parties, such as service providers, generate public or membership spaces and/or host events in public spaces of the metaverse. In embodiments, such service providers can receive accessibility features and aides to implement at their events or in their spaces. In embodiments, a toolkit is provided for service providers to support the service provider expanding the accessibility of their metaverse space and enabling the service provider to offer products and services to a full target client base. For example, for a service provider that is an event host, the service provider may receive a toolkit of environment features where the features in the toolkit are determined according to a set of accessibility characteristics associated with a guest list, purchasers of tickets, users associated with avatars entering the event space, etc. If one or more users with visual impairment sign up for the event or enter the event space, environmental features for audio or haptic guidance or a service avatar to act as a guide may be provided in the toolkit. If one or more users with hearing impairment sign up for the event or enter the event space, environmental features for subtitles or a service avatar to serve as a sign language translator may be provided in the toolkit.

There can be various advantages associated with the technologies described herein. For instance, the technologies disclosed herein can reduce boundaries to necessary services, such as banking and other financial services, through the metaverse for those who may face boundaries to accessing such services in one or both of the metaverse and in person. Further, the technologies disclosed herein can provide for more inclusive “public” spaces within the metaverse, making these spaces available and more comfortable for persons who may otherwise be excluded from such spaces.

Further, the technologies disclosed herein can enable those with disabilities to engage with the public and society in ways they have historically been excluded from, or at least had significant issues with accessing. As a further advantage, the technologies disclosed herein can provide for a centralized accounting of a user's needs for digital accessibility and, by extension, provide for accessibility in all areas of the metaverse without the user being required to continually redisclose or reestablish the user's accessibility needs.

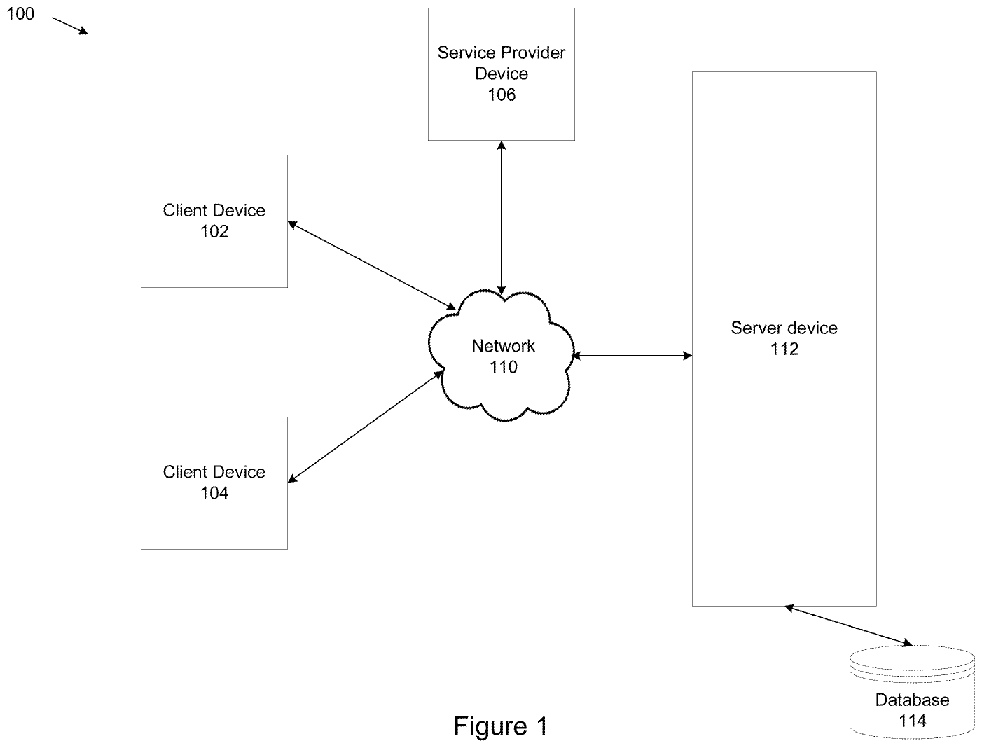

FIG. 1 schematically shows aspects of one example system 100 programmed to provide digital accessibility in the metaverse. In this example, the system 100 can be a computing environment that includes a plurality of client and server devices. In this instance, the system 100 includes client devices 102, 104, a service provider device 106, a server device 112, and a database 114. The client devices 102, 104 and the service provider device 106 can communicate with the server device 112 through a network 110 to accomplish the functionality described herein.

Each of the devices may be implemented as one or more computing devices with at least one processor and memory. Example computing devices include a mobile computer, a desktop computer, a server computer, or other computing device or devices such as a server farm or cloud computing used to generate or receive data.

For instance, in some examples, the devices 102, 104 are virtual and/or augmented reality devices that facilitate the creation of a metaverse in which individuals can interact. The metaverse can be an immersive world that is facilitated through the use of the virtual and augmented reality devices. Examples of such devices include virtual and/or augmented reality headsets that provide a three-dimensional experience associated with the metaverse, for example: Google Glass, Microsoft Halo, Meta Quest, Sony PlayStation VR, Valve Index VR, HTC Vive Pro, or HP Reverb.

In some examples, an individual can enter and interact within the metaverse using a virtual representation of themselves. This representation is referred to as an avatar, which is an icon or figure representing the individual. The avatar can be used to interact within the metaverse and can have certain preferences, settings, and options associated therewith.

In some non-limiting examples, the server device 112 is owned by a financial institution, such as a bank. The client devices 102, 104 and the service provider device 106 can be programmed to communicate with the server device 112 to generate and orchestrate an environment with particular features and/or accessibility aides for a user based on the user's particular accessibility characteristics. Many other configurations are possible.

The example client devices 102, 104 are programmed to facilitate a user's access to the metaverse. Example client devices optionally include assistive components to receive input from and provide feedback to a user and may vary based on the user's preferences and accessibility characteristics. Example assistive input or feedback components include glasses, headsets, screens and other displays, haptic keyboards, a haptic mouse, haptic gloves, adaptive keyboards, high contrast keyboards, head pointers, foot switches, single switch entry devices, sip-and-puff switches, eye-tracking systems, a braille display, dictation systems, magnifiers, text to speech (TTS) systems, etc.

Example client devices 102, 104 are programmed to accept entry of user accessibility characteristics or to determine user accessibility characteristics based on a user's interaction with the device and system. Accessibility characteristics identify a user's access options and limitations and may include, by way of example, visual impairment, hearing impairment, susceptibility to stroke, seizure or migraine, speech impairment, limited dexterity or motor control, etc. Accessibility characteristics may also identify assistive components associated with a user's access device, such as the client devices 102, 104. Identification of assistive components may enable the client devices 102, 104 to determine one or more of a user's accessibility characteristic, or may provide additional means for delivery of environmental feedback from the metaverse to the user.

In examples, the client devices 102, 104 prompts a user to provide the user's accessibility characteristics. The client devices 102, 104 may be programmed to guide a user through entry of the user's accessibility characteristics to ensure complete and effective identification of relevant characteristics. In embodiments, client devices 102, 104 is programmed to evaluate a user's accessibility characteristics based on installed or associated assistive components. In embodiments, client devices 102, 104 is programmed to evaluate a user's accessibility characteristics based on the user's interaction with the device or the system. A user's accessibility characteristics may be determined according to an external profile.

The example service provider device 106 is programmed to facilitate a service provider's access to the metaverse. For example, an event planning or hosting service wishing to provide services to members via the metaverse may use service provider device 106 to design and maintain a metaverse version of the event. In examples, service provider device 106 belongs to a service provider hired by or sponsored by the financial institution or other entity which owns and operates server device 112.

The example server device 112 is programmed to coordinate metaverse access by clients and service parties. Server device 112 organizes accessibility characteristics and associated features and aides for one or more users and provides featured environments and accessibility aides to users in the metaverse according to the user's accessibility characteristics. In embodiments, service device 112 generates toolkits of accessibility features and aides which are provided to service providers to implement in spaces or at events hosted or maintained by the service provider.

The example database 114 is programmed to store accessibility characteristics and associated environmental features or accessibility aides. In embodiments, each accessibility characteristic stored in database 114 may be associated with at least one environmental feature or accessibility aide. In embodiments, each environmental feature or accessibility aide is associated with at least one accessibility characteristic.

Environmental features include, by way of example, adjusting the brightness of a metaverse environment, reducing or eliminating flashing, other reductions in visual stimulation, haptics, subtitles, alternative navigation or guidance features such as tactile or haptic guiderails or auditory directions, etc. Environmental features may be associated with or be applicable to a user's holistic metaverse experience, such that the feature is part of the user's experience in all areas of the metaverse.

In embodiments, environmental features are associated with or applicable to specific areas, services, or venues within the metaverse. Environmental features may be available to and experienced by all users in a metaverse space where the feature is active, or environmental features may be specific to the experience of a particular user while other users in the same metaverse space experience an environment with different features. Users in common metaverse spaces may interact within and with the space even while experiencing environments with different features.

Accessibility aides include, by way of example, a metaverse assistant or service avatar, audible directions, etc. can improve user accessibility by providing a familiar or comfortable means of moving or interacting while in the metaverse. Accessibility tools may be further configured to provide similar accessibility assistance as in the physical world. For example, a user with a vision impairment who is used to using a white cane in the physical world may have an accessibility tool as a digital white cane in the metaverse. The digital white can may provide haptic feedback similar to what the user is accustomed to, such as through a haptic glove or other accessibility device. A service avatar may be, by way of example, a guide avatar, an interpreter, an emotional support avatar, etc. A service avatar may be an artificial intelligence or may be operated by a human, such as support personnel employed by a service provider or an owner/operator of server device 112. Accessibility aides may be integrated with a user's avatar or may be digitally separate.

The network 110 provides a wired and/or wireless connection between the client devices 102, 104, the service provider device 106, and the server device 112. In some examples, the network 110 can be a local area network, a wide area network, the Internet, or a mixture thereof. Many different communication protocols can be used. Although only three devices are shown, the system 100 can accommodate hundreds, thousands, or more of computing devices.

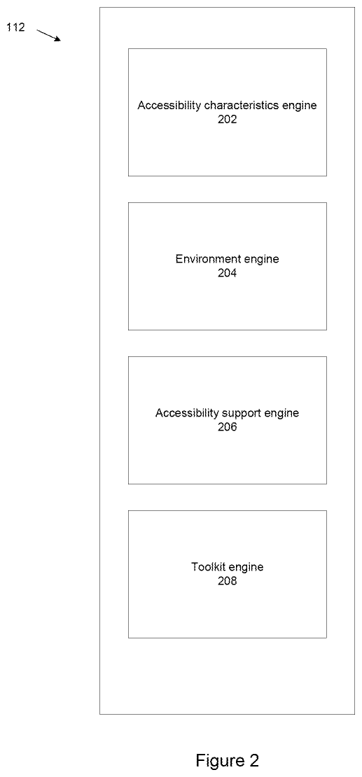

Referring now to FIG. 2, additional details of the server device 112 are shown. In this example, the server device 112 has various logical modules that assist in orchestrating digital accessibility in the metaverse for users. The server device 112 can, in this instance, include an accessibility characteristics engine 202, an environment engine 204, an accessibility support engine 206, and a toolkit engine 208. In other examples, more or fewer digital accessibility engines or engines providing different functionality can be used.

Accessibility characteristics engine 202 is programmed to receive one or more accessibility characteristics, associated with a user, from a user device, such as client devices 102, 104 of FIG. 1. Accessibility characteristics engine 202 receives and processes a user's accessibility characteristics. Accessibility characteristics may be organized into a dedicated accessibility profile. In examples, accessibility characteristics are integrated with a user's overall metaverse profile. Accessibility characteristics may be reflected in a user's avatar.

In embodiments, a user manually enters or has previously entered the user's accessibility characteristics into his or her user profile. The user profile may be a dedicated accessibility characteristics profile, or an overall metaverse or client profile. For example, in a case where server device 112 is owned or operated by a financial institution, the financial institution may maintain a client or member profile for each user who is supported to access the metaverse via server device 112. In such a case, the client or member profile maintained by the financial institution may provide for integration of accessibility characteristics.

In other embodiments, the system automatically determines some or all of a user's accessibility characteristics according to criteria used to evaluate a user's interactions with the metaverse or the system. For example, a user having particular assistive devices associated with the user's profile, e.g., a braille keyboard, triggers to the system to associate a particular accessibility characteristic, e.g., impaired vision, with the user's profile. This determination may be made by a user's dedicated device, such as client devices 102, 104 of FIG. 1, or may be determined by more a central metaverse provision component, such as accessibility characteristics engine 202 of service device 112.

A user's accessibility characteristics may be tied to the user's authentication profile to enter the metaverse. In such embodiments, accessibility characteristics engine 202 incorporates authentication programming. Accessibility characteristics engine 202 retrieves a user's accessibility characteristics in parallel or in sequence with authentication of one or more credentials associated with the user and verifying the user's identity. In embodiments, a user's accessibility characteristics relate to and influence the authentication procedure used to authenticate the user. For example, a particular user has one or more accessibility characteristics related to memory limitations, such that the particular user faces boundaries to authentication based on remembering and entering a password or personal identification number. In this example, the user is provided with an alternative authentication means, such as credentials based on the user's biometrics or another alternative security measure.

Once retrieved from the user's profile by accessibility characteristics engine 202, accessibility characteristics may be sent to or retrieved by environment engine 204 to determine one or more features to provide in a user's featured environment.

Environment engine 204 is programmed to generate and maintain a metaverse environment for a user according to the user's accessibility characteristics. Environment engine 204 receives or retrieves accessibility characteristics and associated environmental features from accessibility characteristics engine 202. Environment engine 204 communicates with a database, such as database 114 of FIG. 1, to retrieve features associated with a particular accessibility characteristic. In other examples, environment engine 204 may include a dedicated characteristic-feature database.

In embodiments, environment engine 204 generates a unique environment for the user. In embodiments, environment engine 204 modifies a default or otherwise standardized environment to provide additional accessibility features to the user. Features may be integrated with a communal metaverse environment such that all users in the space experience the features. Features may be tied to a particular user such that the user is able to access and experience the features, while other users in the same metaverse space experience different features.

For example, a first user, such as a user associated with client device 102 of FIG. 1, enters a common metaverse space, such as a large event space. In this example, the event space is in use for a large, well-populated event. The first user has an accessibility characteristic associated with vision impairment and the first user experiences a featured environment with features including auditory or haptic navigation through the event space.

In parallel, a second user, such as a user associated with client device 104 of FIG. 1, enters the same common metaverse space. The second user has an accessibility characteristic associated with anxiety, in particular social anxiety. The second user experiences a featured environment with features including increased personal space around the second user's avatar. In this example, the first and second users are in the same metaverse space and may even interact with each other, but the second user does not hear or experience the navigation feature experienced by the first user, and the first user does not experience the extended personal space feature experienced by the second user.

Accessibility support engine 206 is programmed to provide real-time accessibility support to a user based on the user's accessibility characteristics. Accessibility support may take the form of an accessibility support aide, such as an accessibility tool or a service avatar. An accessibility tool is generated by the system to increase a user's accessibility based on the user's accessibility characteristics. Accessibility tools may be digital reflections of physical accessibility tools or may be unique to the metaverse. Accessibility tools may be generated once and remain static or may by dynamic and adapt based on the user's situation or the space the user occupies.

A service avatar is an avatar generated to provide accessibility assistance. A service avatar may be an artificial intelligence or may be operated by accessibility support personnel. A service avatar may appear as a person, animal, object, etc. or may be integrated with a user's avatar such that a user's own avatar can execute accessibility support actions according to the user's accessibility characteristics. In embodiments, a user may receive one or more service avatars.

For example, a user with an accessibility characteristic for vision impairment may receive a service avatar to serve as a guide. The service avatar may appear as a dog, a human or humanoid guide, an abstract shape, etc. In another example, a user facing a language barrier may visit his or her financial institution in the metaverse and receive a service avatar to serve as an interpreter. The service avatar provides language translation and, in some examples, may further provide additional background and explanation for concepts, rules, formalities, etc. that a user may struggle to grasp. In yet another example, a user may visit his or her financial institution in the metaverse and, while not having a language barrier, the user may struggle to understand more complex aspects of a loan or other application. The user can request or receive a service avatar to assist the user in navigating complex concepts and rules.

In still another example, a user with mobility issues may visit his or her financial institution in the metaverse. In some instances, the user may choose to visit the financial institution in the metaverse specifically because the user's mobility issues prevent or complicate the user visiting the physical financial institution or because the user's mobility issues prevent or complicate the user from executing a physical signature on documents. The user receives a signatory tool, such as a digital signature tool that can be authenticated without the user physically signing. The signatory tool may be a service avatar who executes a digital signature on the user's behalf. In embodiments, environment engine 204 and accessibility support engine 206 are combined into single accessibility support engine.

Toolkit engine 208 is programmed to package and provide a set of one or more environment features, accessibility aides, or both to a service provider to enable the service provider to implement accessibility features and aides in spaces and at events hosted or operated by the service provider. A toolkit may be automatically populated based on accessibility characteristics associated with users on a guestlist or ticket list. The guestlist or ticket list may be received from a service provider, such as service provider device 106 of FIG. 1. The accessibility characteristics may be determined by and received from accessibility characteristics engine 202.

In another example, a toolkit is populated based on a list of requested features or accessibility aides requested by a service provider. In other examples, a toolkit is populated and continually updated based on user's entering and leaving an event space where a service provider is hosting an event. Contents of a toolkit may be adjusted periodically or on demand according to changes in the accessibility characteristics in the user's present or expected at the event or in the space.

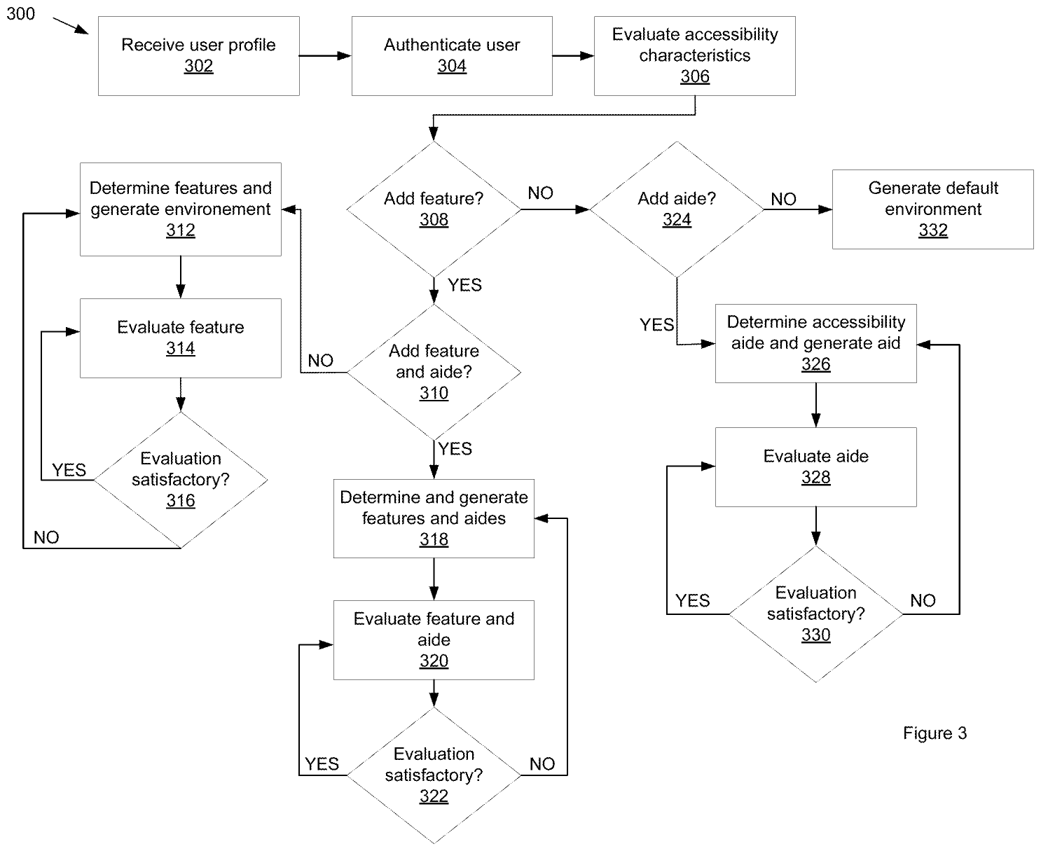

FIG. 3 is a method 300 for determining a set of features for generating a featured environment according to a user's accessibility characteristics. At 302, the system receives a user profile. The user profile identifies the user to the system and may be submitted with a request to enter the metaverse. The user profile contains accessibility characteristics associated with the user.

At 304, the system authenticates the user according to the user profile. The system may use a default authentication system such as password or biometric authentication. In embodiments, the authentication may be modified according to a user's accessibility characteristics. For example, a visually impaired user who may have difficulty entering a password or other identifier using a visual keyboard may be authenticated using a dictation or other auditory system. In another example, a user with an accessibility characteristic for memory impairment can be biometrically verified.

At 306, the system retrieves one or more accessibility characteristics from the user's profile. Accessibility characteristics identify a user's needs and preferences for interacting with the metaverse and include, but are not limited, a user's disabilities that may create obstacles to interacting fully with a default metaverse environment. Examples of accessibility characteristics include hearing and vision impairments, susceptibility to seizures or migraines, language barriers, and may include some phobias (e.g., agoraphobia, trypophobia).

At 308, the system determines whether to add and/or modify one or more environmental features for a user's featured environment based on the user's accessibility characteristics. Environmental features include any number of inclusions or exclusions to the environment to increase a user's accessibility to the environment. For example, for a user with a language barrier, a feature includes subtitles in the user's fluent language for speech in the environment which is not in that fluent language. In another example, for a user with an accessibility characteristic associated with trypophobia, a feature includes eliminating or obscuring the appearance of small holes in the environment the user experiences.

Accessibility characteristics and associated environment features are associated and stored, with those associations, in a database, such as database 114 of FIG. 1. In embodiments, accessibility characteristics are received by an environment engine, such as environment engine 204 of FIG. 2, and the environment engine may actively determine one or more features appropriate for the accessibility characteristic. Features may be fixed in the user's featured environment or may be adjustable or otherwise controlled by the user. A featured environment may be shared or features may be presented only to a particular user, while other user's occupying the same metaverse space experience a default or otherwise differently featured environment. If, at 308, the system determines that the addition or modification of one or more features would be appropriate to provide the user accessibility based on the user's accessibility characteristics, the system may also determine, at 310, whether to provide both features and aides to increase the user's accessibility. As discussed throughout, features provide additions and/or modifications to the metaverse environment to increase accessibility for a user, while aides provide tools or assistants to the user to increase the user's accessibility within an environment.

If, at 310, the system makes a determination to generate only features and not aides, the system may proceed to determine one or more features to add or modify and generate the featured environment, at 312. Generation of the featured environment may be include generating a new feature to an environment, such as a guiderail. Generation of the featured environment may be include modifying an existing feature of an environment, such as lighting level or a user's perceived distance from other avatars in the space or reducing the perception of height for a user with acrophobia. Generation of the featured environment may be include generating a unique environment or may only modify the user's experience of the environment.

At 314, the system evaluates the featured environment and the level of accessibility the featured environment provides the user. The evaluation may involve prompting the user to provide feedback. In embodiments, the system may adjust features automatically or in response to feedback from the user. In other examples, the system evaluates the user's interaction with the environment or system according to predetermined criteria, e.g., speed or case of movement. If, at 316, the level of accessibility is satisfactory, the system returns to 314 continues to monitor and evaluate. If the level of accessibility is unsatisfactory, the system returns to 312 and determines one or more changes or additions to the environmental features based on a reevaluation of the accessibility characteristics.

If, at 310, the system makes a determination to generate both features and aides, the system may proceed to determine one or more features and one or more aides to add or modify and generate the featured environment and the one or more aides, at 318.

At 320, the system evaluates the featured environment and the generated aide and the level of accessibility the featured environment and the generated aide together provides the user. The evaluation may involve the prompting the user to provide feedback. In embodiments, the system may adjust features and/or aides automatically or in direct response to feedback from the user. In other examples, the system evaluates the user's interaction with the environment or system according to predetermined criteria, e.g., speed or case of movement. If, at 322, the level of accessibility is satisfactory, the system returns to 320 and continues to monitor and evaluate. If the level of accessibility is unsatisfactory, the system returns to 318 and determines one or more changes or additions to the environmental features and/or the generated aide based on a reevaluation of the accessibility characteristics.

If, at 308, the system determines not to provide accessibility features, another evaluation, at 324, may be performed to determine whether an accessibility aide should be generated to increase the user's accessibility.

At 326, the system determines one or more accessibility aides for a user. An accessibility aide is an accessibility tool or service avatar. The accessibility aide is generated and associated with the user's avatar. The accessibility aide may be a service avatar. A service avatar may provide emotional support, a guide or navigator, a translator, etc. At 328, the system evaluates the level of accessibility the accessibility aide provides the user. The evaluation may involve prompting the user to provide feedback. In embodiments, the system may adjust accessibility aides automatically or in response to feedback from the user.

Adjustment may involve altering or replacing an accessibility aide in use or generating a new accessibility aide. In other examples, the system evaluates the user's interaction with the environment or system according to predetermined criteria, e.g., speed or case of movement. If, at 330, the level of accessibility is satisfactory, the system returns to 328 and continues to monitor and evaluate. If, at 330, the level of accessibility is unsatisfactory, the system returns to 326 and determines one or more changes or additions to the accessibility aide based on a reevaluation of the accessibility characteristics.

If, at 324, the system determines that neither an accessibility feature nor an accessibility aide is required, a default environment may be generated at 332.

In one example, the method 300 is applied in the context of a digital Automated Teller Machine (ATM) in the metaverse. A user submits his or her profile and a request to enter the metaverse. Once authenticated, the user enters the metaverse, such as by being represented by an avatar, in a featured environment. The features of the featured environment are determined according to accessibility characteristics in the user's profile.

The user, as the user's avatar, visits a digital ATM within the featured environment. The user has accessibility characteristics associated with mobility barriers that prevent the user from interreacting with buttons on the digital ATM. Accordingly, the featured environment includes features such as the digital ATM being operable by verbal commands, and may further include the user's speech being inaudible to other avatars around the user while the user is interacting with the ATM. An accessibility tool, such as a service avatar which operates the buttons for the user according to verbal commands or commands issued outside of the metaverse, may be provided in addition or in alternative to accessibility features.

In this example, the system first generates the featured environment with the feature of the digital ATM being operable by verbal commands. The system evaluates the level of accessibility provided by the feature by querying the user for feedback or evaluating the user's interaction with ATM according to one or more predetermined criteria (e.g., speed of transaction, accuracy of transaction, etc.).

The level of accessibility may be evaluated based on a predetermined threshold. For example, the user may be prompted to rate their accessibility on a ten-point scale, where zero may represent no accessibility and ten may represent full accessibility. A satisfaction threshold may be set at, for example, six, seven, eight, or nine, such that if the user rates their accessibility at six or less (or seven or less, eight or less, or nine or less), that will trigger the system to determine that the predetermined threshold has not been met. If the level of accessibility fails to meet the predetermined threshold, the system revisits the user's accessibility characteristics and determines one or more different or additional features to generated to the user's featured environment. In this example, the system may cancel or adjust the feature of verbal operation of the ATM and generate a service avatar to directly assist the user.

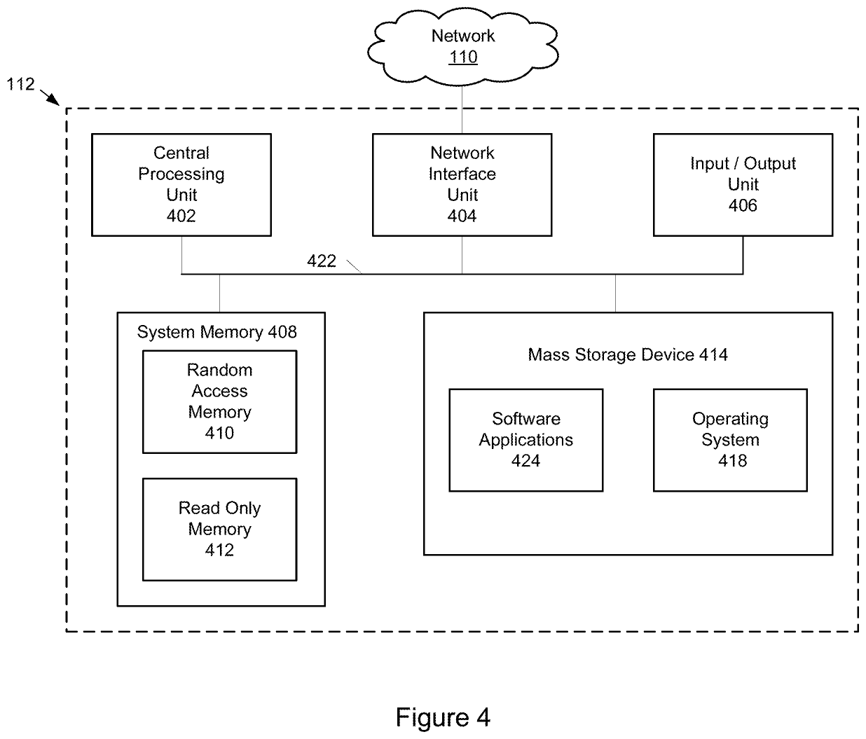

As illustrated in the embodiment of FIG. 4, the example server device 112, which provides the functionality described herein, can include at least one central processing unit (“CPU”) 402, a system memory 408, and a system bus 422 that couples the system memory 408 to the CPU 402. The system memory 408 includes a random access memory (“RAM”) 410 and a read-only memory (“ROM”) 412. A basic input/output system containing the basic routines that help transfer information between elements within the server device 112, such as during startup, is stored in the ROM 412. The server device 112 further includes a mass storage device 414. The mass storage device 414 can store software instructions and data. A central processing unit, system memory, and mass storage device similar to that shown can also be included in the other computing devices disclosed herein. Other devices (e.g., client devices 102, 104, or service provider device 106) may be similarly configured.

The mass storage device 414 is connected to the CPU 402 through a mass storage controller (not shown) connected to the system bus 422. The mass storage device 414 and its associated computer-readable data storage media provide non-volatile, non-transitory storage for the server device 112. Although the description of computer-readable data storage media contained herein refers to a mass storage device, such as a hard disk or solid-state disk, it should be appreciated by those skilled in the art that computer-readable data storage media can be any available non-transitory, physical device, or article of manufacture from which the central display station can read data and/or instructions.

Computer-readable data storage media include volatile and non-volatile, removable, and non-removable media implemented in any method or technology for storage of information such as computer-readable software instructions, data structures, program modules, or other data. Example types of computer-readable data storage media include, but are not limited to, RAM, ROM, EPROM, EEPROM, flash memory or other solid-state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server device 112.

According to various embodiments of the invention, the server device 112 may operate in a networked environment using logical connections to remote network devices through network 110, such as a wireless network, the Internet, or another type of network. The server device 112 may connect to network 110 through a network interface unit 404 connected to the system bus 422. It should be appreciated that the network interface unit 404 may also be utilized to connect to other types of networks and remote computing systems. The server device 112 also includes an input/output controller 406 for receiving and processing input from a number of other devices, including a touch user interface display screen or another type of input device. Similarly, the input/output controller 406 may provide output to a touch user interface display screen or other output devices.

As mentioned briefly above, the mass storage device 414 and the RAM 410 of the server device 112 can store software instructions and data. The software instructions include an operating system 418 suitable for controlling the operation of the server device 112. The mass storage device 414 and/or the RAM 410 also store software instructions and applications 424, that when executed by the CPU 402, cause the server device 112 to provide the functionality of the server device 112 discussed in this document.

Although various embodiments are described herein, those of ordinary skill in the art will understand that many modifications may be made thereto within the scope of the present disclosure. Accordingly, it is not intended that the scope of the disclosure in any way be limited by the examples provided.

1. A computer system for metaverse digital accessibility in a metaverse space, comprising:
one or more processors; and
non-transitory computer-readable storage media encoding instructions which, when executed by the one or more processors, causes the computer system to create:
an accessibility characteristics engine programmed to determine one or more accessibility characteristics associated with a user;
an environment engine programmed to generate an environment for an avatar associated with the user, wherein, based on the one or more accessibility characteristics, the environment engine modifies the environment to generate a modified environment that includes one or more inclusions or exclusions to the environment to increase accessibility of the user within the metaverse space, and wherein the environment engine presents the modified environment to the user while simultaneously presenting the environment to other users within the metaverse space; and
an accessibility support engine programmed to provide an accessibility aide to the avatar associated with the user based on the one or more accessibility characteristics.

2. The computer system of claim 1, wherein the one or more accessibility characteristics comprise at least one of a vision impairment, a hearing impairment, a mobility impairment, a language barrier, a susceptibility to strokes, a susceptibility to seizures, a susceptibility to migraines, and a speech impairment.

3. The computer system of claim 1, wherein the accessibility aide is one or more of an accessibility tool and a service avatar.

4. The computer system of claim 3, wherein the service avatar provides one or more of navigation, interpretation, and emotional support.

5. The computer system of claim 4, wherein the service avatar is generated using artificial intelligence.

6. The computer system of claim 1, wherein the modified environment includes one or more features, the one or more features including lighting with reduced brightness, reduction or elimination of flashing lights, a guiderail, auditory directions, haptic directions, tactile directs, a user's perception of spare around them, a user's perception of height, and subtitles.

7. The computer system of claim 6, further comprising a database, the database including one or more feature-characteristic pairs, wherein the each of the one or more feature-characteristic pairs comprise an accessibility characteristic and one or more associated feature.

8. The computer system of claim 1, further comprising a toolkit engine programmed to generate a toolkit of one or more features and one or more aides; and
wherein the toolkit is provided to a service provider such that the one or more features and the one or more aides are configured to be implemented in an event space by the service provider.

9. The computer system of claim 8, wherein the one or more features and the one or more aides in the toolkit are determined according to a guestlist associated with the event space by the service provider.

10. The computer system of claim 8, wherein the one or more features and the one or more aides in the toolkit are determined according to a first set of accessibility characteristics associated with one or more users present in the event space.

11. The computer system of claim 10, wherein the one or more features and the one or more aides in the toolkit are updated according to a second set of accessibility characteristics associated with one or more users entering the event space.

12. The computer system of claim 10, wherein the one or more features and the one or more aides in the toolkit are updated according to a second set of accessibility characteristics associated with one or more users exiting the event space.

13. A method of providing digital accessibility to a user in a metaverse space comprising:
determining one or more accessibility characteristics associated with the user; and
generating a featured environment to the metaverse space for an avatar of the user to interact in, the featured environment including one or more features, wherein, based on the one or more accessibility features, the featured environment includes a modified environment having one or more inclusions or exclusions to at least one each feature of the one or features to increase accessibility of the user within the metaverse space, and wherein presenting the modified environment to the user while simultaneously presenting the featured environment to other users within the metaverse space.

14. The method of claim 13, further comprising evaluating a level of accessibility experienced by the user.

15. The method of claim 14, further comprising determining that the level of accessibility experienced by the user is below a predetermined threshold; and
in response to determining that the level of accessibility experienced by the user is below the predetermined threshold, regenerating the featured environment to include an additional feature.

16. The method of claim 13, further comprising generating a service avatar to provide real-time accessibility support to the avatar of the user.

17. The method of claim 13, wherein determining the one or more accessibility characteristics associated with the user comprises receiving a user profile and retrieving the one or more accessibility characteristics form the user profile.

18. The method of claim 13, further comprising authenticating the user, wherein a method of authentication is selected according the one or more accessibility characteristics.

19. The method of claim 18, wherein the method of authentication is selected from keyboard password authentication, dictation password authentication, and biometric authentication.

20. The method of claim 13, wherein determining the one or more accessibility characteristics associated with the user comprises:
determining one or more accessibility devices are associated with the user; and
determining one or more accessibility characteristics associated with the one or more accessibility devices.
